(19) United States
(12) Patent Application Publication
(10) Pub. No.: US 2026/0292367 A1
(43) Pub. Date: Sep. 24, 2026

(54) IMAGE SENSOR AND DRIVING METHOD THEREOF

(71) Applicant: Samsung Electronics Co., Ltd., Suwon-si (KR)

(72) Inventors: Haewon LEE, Suwon-si (KR); Junoh KIM, Suwon-si (KR)

(73) Assignee: Samsung Electronics Co., Ltd., Suwon-si (KR)

(21) Appl. No.: 19/393,827

(22) Filed: Nov. 19, 2025

(30) Foreign Application Priority Data
Mar. 20, 2025 (KR) 10-2025-0035948

(51) Int. Cl. H04N 25/778; H04N 25/709; H04N 25/76; H04N 25/78

(52) U.S. Cl. CPC H04N 25/778; H04N 25/709; H04N 25/7795; H04N 25/78

(57) ABSTRACT

An image sensor according to some example embodiments may include a photoelectric conversion element configured to generate photo charge, a first node configured to accumulate photo charge generated from the photoelectric conversion element, a transfer transistor connected between the first node and the photoelectric conversion element, a reset transistor connected between the first node and a driving voltage, a common source transistor including a gate connected to the first node and connected between a second node and a reference voltage, and configured to amplify a voltage caused by the photo charge, and a source follower transistor including a gate connected to the second node and having an end connected to the driving voltage, and configured to buffer a voltage caused by the photo charge.

### CROSS-REFERENCE TO RELATED APPLICATION

This application claims priority to and the benefit of Korean Patent Application No. 10-2025-0035948 filed with the Korean Intellectual Property Office on Mar. 20, 2025, the entire contents of which are incorporated herein by reference.

### BACKGROUND

### (a) Field

The present disclosure relates to image sensors and methods for driving the image sensor.

### (b) Description of the Related Art

An image sensor is a device that may capture two-dimensional or three-dimensional images of external objects. Image sensors create images of objects using photoelectric conversion elements that react to the intensity of light reflected from the object. Recently, with the development of CMOS (Complementary Metal-Oxide Semiconductor) technology, CMOS image sensors using CMOS are being widely used.

The pixel circuit of the image sensor may typically include a source-follower amplifier structure or a common-source amplifier structure. When using a source-follower amplifier architecture, an RC delay may be reduced, however there may also be lower conversion gain. On the other hand, when using a common-source amplifier structure, there may be a higher conversion gain, however there is additionally a problem of increased RC delay.

### SUMMARY

The present disclosure attempts to provide image sensors and methods of driving the image sensor capable of increasing the dynamic range through a pixel circuit switchable between a source-follower amplifier and a common-source amplifier structure.

According to some example embodiments of the present inventions for solving these technical problems, an image sensor may include a photoelectric conversion element configured to generate photo charge, a first node configured to accumulate the photo charge generated from the photoelectric conversion element, a transfer transistor connected between the first node and the photoelectric conversion element, a reset transistor connected between the first node and a driving voltage, a common source transistor including a gate connected to the first node and connected between a second node and a reference voltage, the common source transistor configured to amplify a voltage caused by the photo charge, and a source follower transistor including a gate connected to the second node and having an end connected to the driving voltage, the source follower transistor configured to buffer the voltage caused by the photo charge.

A method for driving an image sensor according to some example embodiments may include transferring a first photo charge generated from a photoelectric conversion element to a first node, amplifying a voltage caused by the first photo charge based on an operation of a common source transistor including a gate connected to the first node and connected between a second node and a reference voltage, and an operation of a mode transistor connected between the first node and the second node, transferring a second photo charge generated from the photoelectric conversion element to the first node, and buffering a voltage caused by the second photo charge based on operation of a source follower transistor including a gate connected to the second node and having an end connected to a driving voltage, and an operation of the mode transistor.

An image sensor according to some example embodiments may include a pixel circuit comprising a photoelectric conversion element configured to generate photo charge, a first node configured to accumulate the photo charge generated from the photoelectric conversion element, a mode transistor including a gate configured to receive a mode control signal and connected between the first node and a second node, a common source transistor including a gate connected to the first node and connected between the second node and a reference voltage, the common source transistor configured to amplify a voltage caused by the photo charge, and a source follower transistor including a gate connected to the second node and having an end connected to a driving voltage, the source follower transistor configured to buffer the voltage caused by the photo charge, a row driver configured to control a signal level of the mode control signal based on an illumination level, and a voltage generator configured to control a magnitude of the reference voltage based on the illumination level.

### BRIEF DESCRIPTION OF THE DRAWINGS

FIG. 1 is a block diagram for explaining an image sensor according to some example embodiments of the present disclosure.

FIG. 2 is a circuit diagram for explaining a pixel circuit according to some example embodiments of the present disclosure.

FIG. 3 is a circuit diagram for explaining a pixel circuit according to some example embodiments of the present disclosure.

FIG. 4 is a circuit diagram for explaining a pixel circuit according to some example embodiments of the present disclosure.

FIG. 5 is a circuit diagram for explaining a pixel circuit according to some example embodiments of the present disclosure.

FIG. 6 is a circuit diagram for explaining a pixel circuit according to some example embodiments of the present disclosure.

FIG. 7 is a circuit diagram for explaining a pixel circuit according to some example embodiments of the present disclosure.

FIG. 8 is a flowchart for explaining a method for driving an image sensor according to some example embodiments of the present disclosure.

FIG. 9 is a flowchart for explaining a method for driving an image sensor according to some example embodiments of the present disclosure.

FIG. 10 is a flowchart for explaining a method for driving an image sensor according to some example embodiments of the present disclosure.

FIG. 11 is a timing diagram for explaining a method for driving an image sensor according to some example embodiments of the present disclosure.

FIG. 12 is a timing diagram for explaining a method for driving an image sensor according to some example embodiments of the present disclosure.

FIG. 13 is a block diagram for explaining a computing device according to some example embodiments of the present disclosure.

FIG. 14 is a block diagram for explaining a vehicle according to some example embodiments of the present disclosure.

### DETAILED DESCRIPTION OF THE EMBODIMENTS

In the following detailed description, only certain embodiments of the present inventions have been shown and described, simply by way of illustration. As those skilled in the art would realize, the described embodiments may be modified in various different ways, all without departing from the spirit or scope of the present inventions.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

Further, expressions written in the singular forms can be comprehended as the singular forms or plural forms unless clear expressions such as “a”, “an”, or “single” are used. Terms including an ordinal number, such as first and second, are used for describing various constituent elements, but the constituent elements are not limited by the terms. These terms are used only to discriminate one constituent element from other constituent elements.

Further, expressions using “predetermined” may alternatively or additionally be “desired,” “determined,” “selected” and/or the like.

Hereinafter, the present disclosure will be described in more detail through examples. These examples are just for illustrating the present disclosure, and the right protection scope of the present disclosure is not limited by the examples.

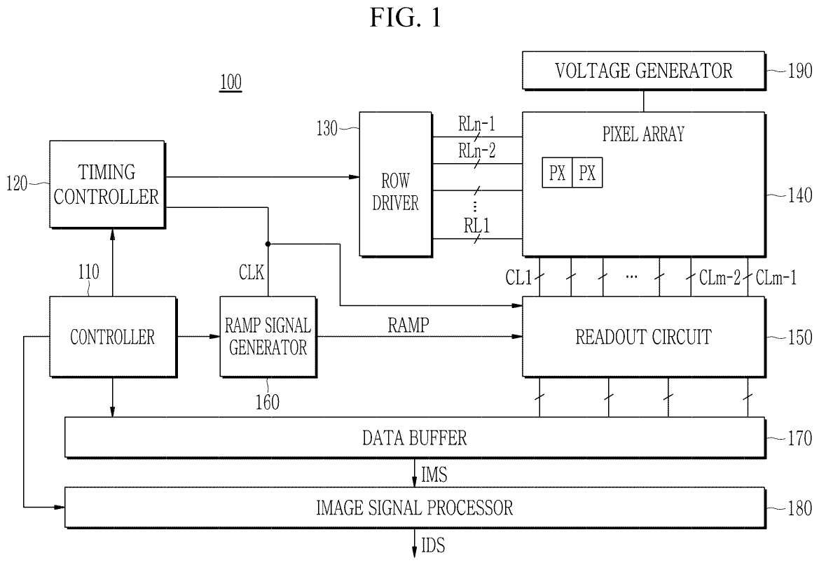

FIG. 1 is a block diagram for explaining an image sensor according to some example embodiments of the present disclosure.

Referring to FIG. 1, the image sensor 100 may convert light received from the outside into an electrical signal to generate an image output signal IMS. An image output signal IMS may be provided to an image signal processor 180.

The image sensor 100 may be mounted on an electronic device having an image or light sensing function. For example, the image sensor 100 may be mounted on electronic devices such as a camera, a smartphone, a wearable device, an Internet of Things (IoT) device, a home appliance, a tablet PC (Personal Computer), a PDA (Personal Digital Assistant), a PMP (portable multimedia player), a navigation system, a drone, an advanced driver assistance system (ADAS), and/or the like. Alternatively, the image sensor 100 may be mounted on an electronic device provided as a component in a vehicle, furniture, manufacturing equipment, door, or various measuring instruments.

Meanwhile, the frame cycle of the image sensor 100 may be defined as the times required to read the reset voltage and pixel voltage from all pixels included in the pixel array 140. In some example embodiments, a frame period may be equal to or greater than the product of the number of a plurality of row lines RL and the horizontal period. The shorter the frame cycle of the image sensor, the more image data IDS the image sensor 100 may generate during the same period of time. In one frame cycle, the image sensor 100 may generate one image data IDS.

As illustrated in FIG. 1, the image sensor 100 may include a controller 110, a timing controller 120, a row driver 130, a pixel array 140, a readout circuit 150, a ramp signal generator 160, a data buffer 170, an image signal processor 180, and a voltage generator 190. In FIG. 1, the image sensor 100 is illustrated as including an image signal processor 180, but the present inventions are not limited thereto, and, for example, the image signal processor 180 may be located outside the image sensor 100.

The controller 110 may control each component 120, 130, 140, 150, 160, 170, 180, 190 included in the image sensor 100. The controller 110 may also control the operation timing of each component 120, 130, 140, 150, 160, 170, 180, 190 using control signals.

In some example embodiments, the controller 110 may control the ramp signal generator 160 to adjust the ramp signal RAMP, which is a reference signal generated by the ramp signal generator 160. In some example embodiments, the controller 110 may control the timing controller 120 to adjust the operating timing of elements within the pixel array 140 via the row driver 130.

The timing controller 120 may generate a signal that serves as a reference for the operation timing of the components of the image sensor 100. The timing controller 120 may control the timing of the row driver 130, the readout circuit 150, and the ramp signal generator 160. The timing controller 120 may provide control signals that control the timing of the row driver 130, the readout circuit 150, and the ramp signal generator 160. In some example embodiments, the timing controller 120 may generate a clock signal CLK. The timing controller 120 may control the timing of the row driver 130, the readout circuit 150, and the ramp signal generator 160 based on the clock signal CLK.

The pixel array 140 may include a plurality of pixels in addition toa plurality of row lines RL and a plurality of column lines CL each connected to the plurality of pixels.

In some example embodiments, each pixel may include at least one photoelectric conversion element (or photosensitive element). A photoelectric conversion element may detect incident light and convert the incident light into an electrical signal according to the amount of light, e.g., a plurality of analog pixel signals. The level of the analog pixel signal output from the photoelectric conversion element may increase as the amount of charge output from the photoelectric conversion element increases. That is, the level of the analog pixel signal output from the photoelectric conversion element may increase as the amount of light received within the pixel array 140 increases.

A plurality of row lines RL1 to RLn−1; RL extend in a first direction and may be connected to a plurality of pixels arranged along the first direction. For example, a plurality of row lines RL may transfer control signals output from a row driver 130 to elements provided in a pixel, such as transistors. In addition to the row line RL, other signal lines may be arranged in the first direction. A plurality of column lines CL1 to CLm−1; CL extend in a second direction intersecting the first direction and may be connected to a plurality of pixels PX arranged along the second direction. A column line CL may transmit pixel signals output from a plurality of pixels PX to a readout circuit 150.

The row driver 130 may generate a control signal for driving the pixel array 140 in response to a control signal of the timing controller 120, and may provide the control signal to a plurality of pixels PX of the pixel array 140 through a plurality of row lines RL. In some example embodiments, the row driver 130 may be controlled to detect incident light on a pixel PX by row line unit. A row line unit may include at least one row line RL.

The readout circuit 150 may convert pixel signals (or electrical signals) from pixels PX connected to a row line RL selected from among a plurality of pixels PX into pixel values representing the amount of light in response to a control signal from the timing controller 120. The readout circuit 150 may include a correlated double sampling circuit, an analog-to-digital converter (ADC) circuit, etc.

Meanwhile, in FIG. 1, the readout circuit 150 is illustrated as being connected to the pixel array 140 through a plurality of column lines CL, but the present disclosure is not limited thereto, and the readout circuit 150 may be included in the pixel array 140. When a readout circuit 150 is included within the pixel array 140, an analog signal within the pixel array 140 is converted into a digital signal, and the digital signal may be directly transmitted to the data buffer 170.

Although not shown in FIG. 1, the readout circuit 150 may include a correlated double sampling (CDS) circuit. The correlated double sampling circuit may include a plurality of comparators, each of which may compare a pixel signal received from a pixel array 140 via a plurality of column lines CL with a ramp signal RAMP from a ramp signal generator 160. Specifically, the correlated double sampling circuit may compare a received pixel signal with a ramp signal RAMP and output the comparison result to an analog-to-digital conversion circuit.

A plurality of pixel signals output from a plurality of pixels PX may have deviations due to unique characteristics of each pixel (e.g., fixed pattern noise (FPN), etc.) and/or deviations due to differences in characteristics of pixel circuits (e.g., transistors for outputting charge stored in photoelectric conversion elements within the pixels) for outputting pixel signals from the pixels PX. In order to compensate for the deviation between a plurality of pixel signals output through a plurality of column lines CL, a reset component (e.g., reset voltage) and a sensing component (e.g., sensing voltage) are obtained for the pixel signals, and the difference between them (e.g., the difference between the reset voltage and the sensing voltage) is extracted as a valid signal component. This process is called correlated double sampling. A correlated double sampling circuit may output a comparison result obtained by applying a correlated double sampling technique to a received pixel signal.

The analog-to-digital conversion circuit may generate and output pixel values corresponding to a plurality of pixels in units of rows by converting the comparison results of the correlated double sampling circuit into digital data. An analog-to-digital conversion circuit may include a plurality of counters. The counter may be implemented as, for example, an up-counter and an arithmetic circuit whose count value sequentially increases based on a counting clock signal, an up/down counter, and/or a bit-wise inversion counter. A plurality of counters may be connected to the outputs of each of a plurality of comparators. Each of the plurality of counters may count comparison results output from a corresponding comparator and output digital data (e.g., pixel values) according to the counting results.

A ramp signal generator 160 may generate a ramp signal RAMP, which is a reference signal, and transmit it to a readout circuit 150. The ramp signal generator 160 may include a current source, a resistor, and a capacitor. A ramp signal generator 160 may generate a plurality of ramp signals that fall or rise with a slope determined according to the magnitude of current of a variable current source or the resistance value of a variable resistor by controlling the ramp voltage, which is a voltage applied to a ramp resistor, by controlling the magnitude of current of a variable current source or the resistance value of a variable resistor.

The data buffer 170 may store pixel values of a plurality of pixels PX connected to a selected column line CL transmitted from the readout circuit 150. The data buffer 170 may output the stored pixel value as an image output signal IMS to the image signal processor 180 in response to an enable signal from the controller 110.

The image signal processor 180 may perform image signal processing on an image output signal IMS received from a data buffer 170. For example, the image signal processor 180 may receive a plurality of image output signals IMS from the data buffer 170 and synthesize the received image output signals IMS to generate image data IDS.

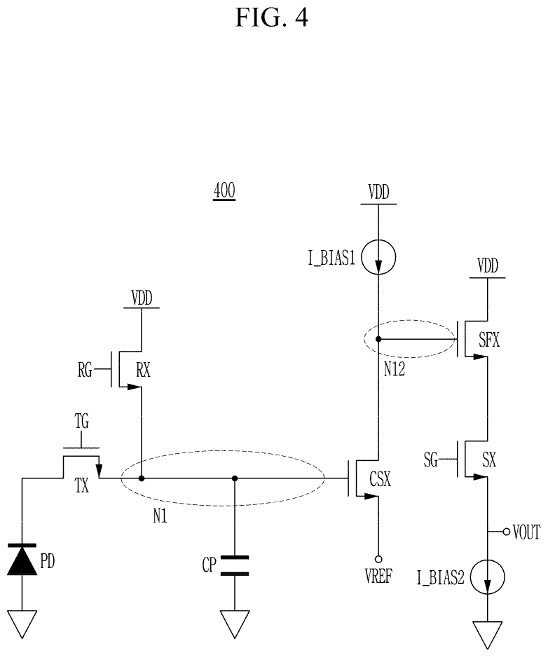

A voltage generator 190 may output a voltage for driving a pixel circuit included in a pixel array 140. A voltage generator 190 may output a driving voltage and a reference voltage to, for example, a pixel array 140. The voltage generator 190 may adjust the magnitude of the reference voltage based on the amount of light reflected from an external object, e.g., the illumination level. Specific details are explained further in FIG. 4 and below.

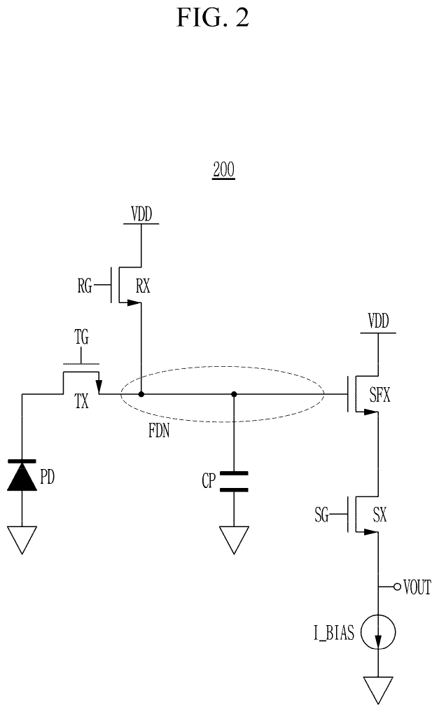

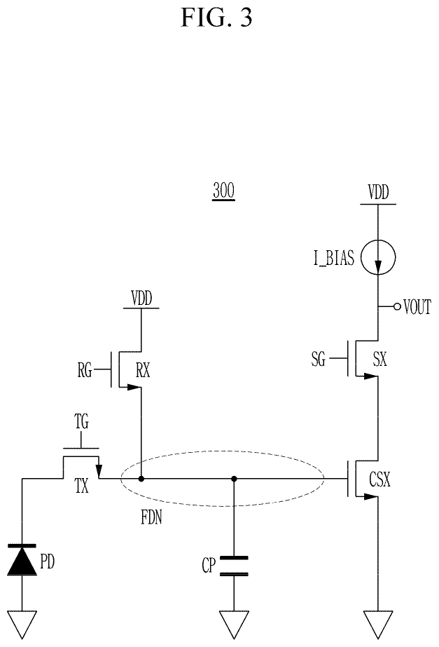

FIGS. 2 and 3 are circuit diagrams for explaining a pixel circuit according to some example embodiments of the present disclosure. Specifically, FIG. 2 illustrates a pixel circuit 200 including a structure of a source-follower amplifier, and FIG. 3 illustrates a pixel circuit 300 including a structure of a common-source amplifier.

Referring to FIG. 2, the pixel circuit 200 may include a photoelectric conversion element PD, a transfer transistor TX, a reset transistor RX, a selection transistor SX, and a source follower transistor SFX. That is, the pixel circuit 200 may substantially have or have a 4T structure. Control signals TG, RG, SG received from a row driver 130 in FIG. 1 may be applied to the pixel circuit 200.

A photoelectric device PD may generate photo charge proportional to the intensity of light. For example, the photoelectric device PD may include, but is not limited to, at least one of a photo diode, a photo transistor, a photo gate, a pinned photo diode (PPD), and combinations thereof.

A transfer transistor TX may be connected between a photoelectric device PD and a floating diffusion node FDN. One end of the transfer transistor TX may be connected to the output end of the photoelectric device PD, and the other end of the transfer transistor TX may be connected to a floating diffusion node FDN. The transfer transistor TX may be controlled by a transfer control signal TG. When the transfer transistor TX is turned on, charge generated in the photoelectric device PD may be transferred to the floating diffusion node FDN. When the transfer transistor TX is turned off, charge generated in the photoelectric device PD may not be transferred to the floating diffusion node FDN.

A floating diffusion node FDN may receive charge from a photoelectric device PD through a transfer transistor TX as discussed above and accumulate the received charge. A floating diffusion node FDN may form a parasitic capacitor and/or an actual capacitor element CP connected as shown in FIG. 2. Depending on the amount of charge accumulated in the floating diffusion node FDN, the potential of the gate electrode of the source follower transistor SFX may vary.

A reset transistor RX may be connected between a power supply voltage line supplying a driving voltage VDD and a floating diffusion node FDN. A driving voltage VDD may be applied to one end of the reset transistor RX, and the other end of the reset transistor RX may be connected to a floating diffusion node FDN. The reset transistor RX may be controlled by a reset control signal RG. When the reset transistor RX is turned on by the reset control signal RG, a predetermined electrical potential (e.g., driving voltage VDD) provided to the drain of the reset transistor RX may be transferred to the floating diffusion node FDN. Accordingly, when the reset transistor RX is turned on, the photo charge accumulated in the floating diffusion node FDN are discharged, so that the floating diffusion node FDN may be set to the driving voltage VDD.

One end of the selection transistor SX may be connected to a source follower transistor SFX, and the other end of the selection transistor SX may be connected to a column line CL in FIG. 1. The selection transistor SX may be controlled by a selection control signal SG. The row driver 130 may select a unit pixel to be read row by row through a selection control signal SG. When the selection transistor SX is turned on, the output voltage VOUT may be output as a pixel signal to the column line CL in FIG. 1. The column line CL in FIG. 1 may be one of the first to m-th column lines CL1 to CLm−1 in FIG. 1. The pixel signal VOUT may include a reset signal corresponding to a reset operation, an image signal corresponding to a charge accumulation operation, etc.

The gate of the source follower transistor SFX may be connected to a floating diffusion node FDN. A driving voltage VDD may be applied to one end of a source follower transistor SFX, and the other end of the source follower transistor SFX may be connected to a selection transistor SX. The source follower transistor SFX acts as a buffer and may buffer a signal depending on the amount of charge charged in the floating diffusion node FDN.

Referring to FIG. 3, the pixel circuit 300 may include a photoelectric conversion element PD, a transfer transistor TX, a reset transistor RX, a selection transistor SX, and a common source transistor CSX. That is, the pixel circuit 300 may substantially have or have a 4T structure. Below, the differences from the pixel circuit 200 illustrated in FIG. 2 will be mainly explained.

One end of the selection transistor SX may be connected to a column line CL in FIG. 1, and the other end of the selection transistor SX may be connected to a common source transistor CSX. The gate of the common source transistor CSX may be connected to a floating diffusion node FDN. One terminal of the common source transistor CSX may be connected to the selection transistor SX, and the other terminal of the common source transistor CSX may be grounded. The common source transistor CSX acts as an amplifier and may amplify a signal depending on the amount of charge stored in the floating diffusion node FDN.

The pixel circuit 200 illustrated in FIG. 2 and the pixel circuit 300 illustrated in FIG. 3 may have different operating characteristics due to differences in their respective circuit configurations.

Specifically, the pixel circuit 200 illustrated in FIG. 2 may have a structure of a source-follower amplifier as described above, and the potential of the floating diffusion node FDN may have a smaller amplification by the source follower transistor SFX. The conversion gain of a source follower transistor SFX may be, for example, less than 1, but close to 1 (e.g., about or exactly 0.01 to about or exactly 0.99).

On the other hand, the pixel circuit 300 illustrated in FIG. 3 may have a structure of a common-source amplifier as described above, and the potential of the floating diffusion node FDN may have a greater amplification by the common source transistor CSX. The conversion gain of a common source transistor CSX may have a value of, for example, 20 or more (e.g., about or exactly 20 to about or exactly 100). That is, the structure of a common-source amplifier may have a larger conversion gain compared to the structure of a source-follower amplifier.

For example, the structure of the source follower amplifier may have a smaller value of the equivalent resistance (e.g., the readout resistance) as viewed from the output terminal where the pixel signal VOUT is output compared to the structure of the common source amplifier. Accordingly, since the RC delay value generated by the readout resistor and the column line CL in FIG. 1 is smaller in the structure of the source-follower amplifier than in the common-source amplifier, the settling time of the output signal in the structure of the source-follower amplifier may be smaller than in the structure of the common-source amplifier.

A pixel circuit according to some example embodiments of the present disclosure may achieve higher conversion gain while reducing RC delay by configuring both the structure of the source-follower amplifier and the structure of the common-source amplifier described above. Alternatively, a pixel circuit according to some example embodiments of the present disclosure may configure a structure that is switchable between a source-follower amplifier and a common-source amplifier structure, thereby increasing the dynamic range by obtaining an improved conversion gain according to a high-illuminance environment and a low-illuminance environment.

FIG. 4 is a circuit diagram for explaining a pixel circuit according to some example embodiments of the present disclosure.

Referring to FIG. 4, the pixel circuit 400 may include a photoelectric conversion element PD, a transfer transistor TX, a reset transistor RX, a selection transistor SX, a common source transistor CSX and a source follower transistor SFX. Below, the differences between the pixel circuit 200 illustrated in FIG. 2 and the pixel circuit 300 illustrated in FIG. 3 will be mainly explained.

The gate of the common source transistor CSX may be connected to the first node N1. The first node N1 may correspond to a floating diffusion node FDN illustrated in FIGS. 2 and 3. One end of a common source transistor CSX may be connected to a secondary node N12 that is different from a first node N1, and a reference voltage VREF may be applied to the other end of the common source transistor CSX.

The gate of the source follower transistor SFX may be connected to a secondary node N12. A driving voltage VDD may be applied to one end of a source follower transistor SFX, and the other end of the source follower transistor SFX may be connected to a selection transistor SX.

One end of the selection transistor SX may be connected to a source follower transistor SFX, and the other end of the selection transistor SX may be connected to a column line CL in FIG. 1. The selection transistor SX may be controlled by a selection control signal SG.

The potential due to the charge accumulated in the first node N1 may be amplified by the common source transistor CSX. The amplified potential may be applied to the gate of the source follower transistor SFX through the secondary node N12 and may be buffered by the source follower transistor SFX.

The conversion gain in the pixel circuit 400 illustrated in FIG. 4 may have a value equal to the product of the conversion gain of the common source transistor CSX and the conversion gain of the source follower transistor SFX. As described with reference to FIG. 2, since the value of the conversion gain of the source follower transistor SFX has a value close to 1 (e.g., we may assume the value is one to simplify a numerical relationship), the conversion gain in the pixel circuit 400 illustrated in FIG. 4 may have a value close to the conversion gain of the common source transistor CSX.

Additionally, the readout resistance of the pixel circuit 400 illustrated in FIG. 4 may have a value similar to the readout resistance in the source-follower amplifier structure described with reference to FIG. 2. Therefore, the pixel circuit 400 may achieve higher conversion gain and SNR (Signal to Noise Ratio) while reducing RC delay.

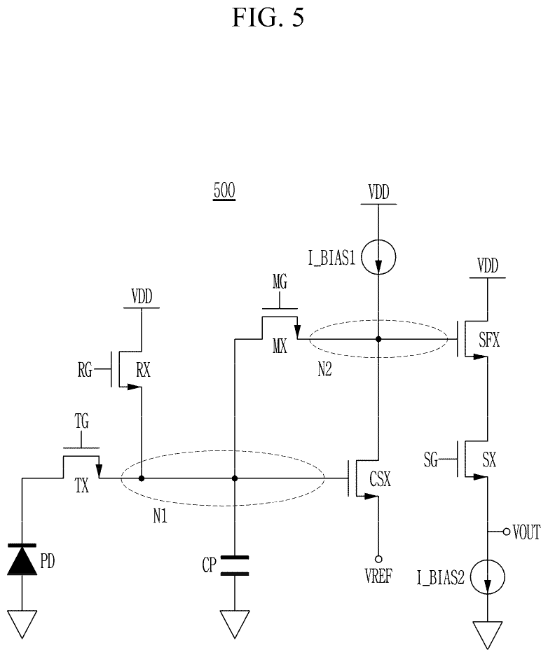

FIG. 5 is a circuit diagram for explaining a pixel circuit according to some example embodiments of the present disclosure. Below, the differences from the pixel circuit 400 illustrated in FIG. 4 will be mainly explained.

Referring to FIG. 5, the pixel circuit 500 may further include a mode transistor MX. One end of the mode transistor MX may be connected to a first node N1, and the other end of the mode transistor MX may be connected to a second node N2. The second node N2 being similar to the secondary node N12 with the addition of the mode transistor MX connection. The mode transistor MX may be controlled by a mode control signal MG. The row driver 130 in FIG. 1 may turn on or off the mode transistor MX by changing the signal level of the mode control signal MG. The row driver 130 may change the signal level of the mode control signal MG based on the illumination level of the object.

Here, the illumination level may mean the amount of light reflected by an object and incident on a photoelectric device PD, or the degree of illumination. If the lighting level is lower than a predetermined value (for example, an illumination threshold value), it may be determined that it is a low-light environment, and if the lighting level is higher than a predetermined value, it may be determined that it is a high-light environment. That is, a low-light environment in which the illumination level is lower than a predetermined value may be responded to when the incident light reflected by the object is photoelectrically converted into a charge amount lower than the predetermined charge amount by the photoelectric conversion element, and a high-light environment in which the illumination level is higher than the predetermined value may be responded to when the incident light reflected by the object is photoelectrically converted into a charge amount higher than the predetermined charge amount by the photoelectric conversion element. The predetermined charge amount may reflect a working efficiency or other property of the photoelectric device PD which may vary at different illumination levels.

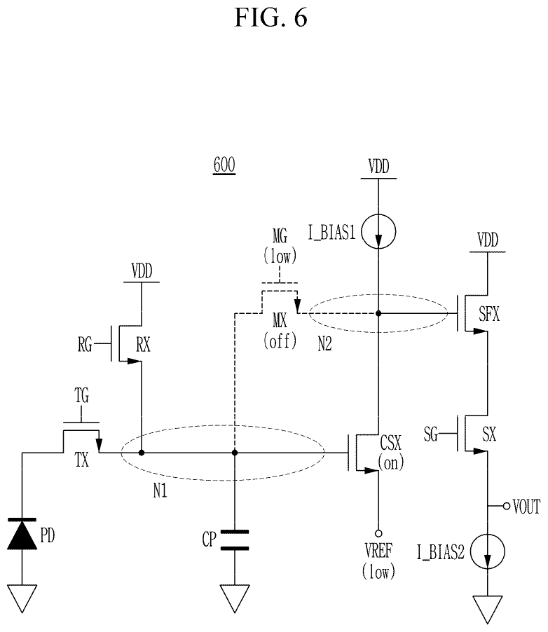

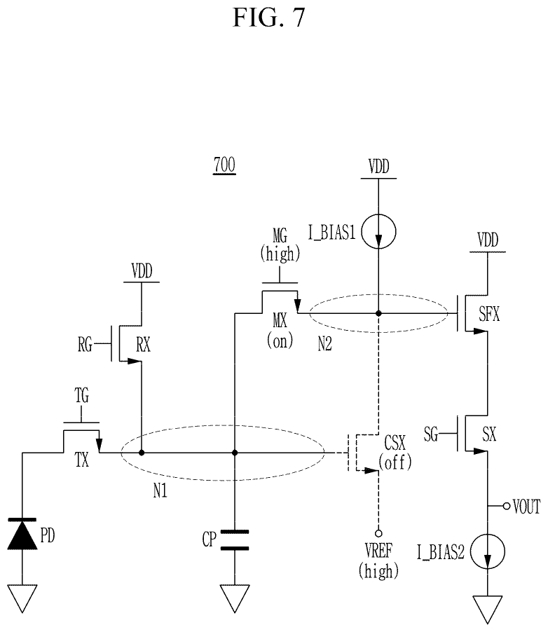

In some example embodiments, the pixel circuit 500 may perform different operations when the illumination level is lower than a predetermined value and when the illumination level is higher than a predetermined value. Specifically, the pixel circuit 500 may operate in a high gain mode to obtain a relatively larger conversion gain when the illumination level is lower than a predetermined value, and may operate in a low gain mode to obtain a relatively smaller conversion gain when the illumination level is higher than a predetermined value. Specific details are described later with reference to FIGS. 6 and 7.

FIGS. 6 and 7 are circuit diagrams for explaining a pixel circuit according to some example embodiments of the present disclosure. Specifically, FIG. 6 is a circuit diagram for explaining the operation of the pixel circuit 600 in high gain mode, and FIG. 7 is a circuit diagram for explaining the operation of the pixel circuit 700 in low gain mode.

Referring to FIG. 6, a low-level mode control signal MG may be applied to the gate of the mode transistor MX in high gain mode. The row driver 130 in FIG. 1 may apply a low-level mode control signal MG to the gate of the mode transistor MX. The mode transistor MX may be turned off by a low level mode control signal MG.

A reference voltage VREF may be applied to the other terminal of the common source transistor CSX. A voltage generator 190 in FIG. 1 may apply a reference voltage VREF to the other terminal of a common source transistor CSX. In high gain mode, the reference voltage VREF may be of a magnitude that causes the common source transistor CSX to turn on.

Specifically, the common source transistor CSX may be turned on when the gate-source voltage of the common source transistor CSX is greater than the threshold voltage of the common source transistor CSX. Here, the gate-source voltage of the common source transistor CSX may be the difference between the potential of the first node N1 and the reference voltage VREF.

For example, assuming that the driving voltage VDD is about or exactly 2.8V, the voltage change of the first node N1 by the photoelectric conversion element PD in the high gain mode, which is a low-light environment, is relatively smaller compared to the high-light environment, so the voltage of the first node N1 may be assumed to be about or exactly 2.7V. And, assuming that the threshold voltage of the common source transistor CSX is, for example, about or exactly 0.2V, the voltage generator 190 in FIG. 1 may control the magnitude of the reference voltage VREF to have a value smaller than about or exactly 2.5V (e.g., about or exactly 0.1V to about or exactly 2.49V). Through the above-described operation, the common source transistor CSX may be turned on, and the potential of the first node N1 may be amplified by the conversion gain of the common source transistor CSX.

Referring to FIG. 7, a high level mode control signal MG may be applied to the gate of the mode transistor MX in low gain mode. The row driver 130 in FIG. 1 may apply a high level mode control signal MG to the gate of the mode transistor MX. The mode transistor MX may be turned on by a high level mode control signal MG.

A reference voltage VREF may be applied to the other terminal of the common source transistor CSX. A voltage generator 190 in FIG. 1 may apply a reference voltage VREF to the other terminal of a common source transistor CSX. In low gain mode, the reference voltage VREF may be of a magnitude that causes the common source transistor CSX to turn off.

Specifically, when the gate-source voltage of the common source transistor CSX is smaller than the threshold voltage of the common source transistor CSX, the common source transistor CSX may be turned off. Here, the gate-source voltage of the common source transistor CSX may be the difference between the potential of the first node N1 and the reference voltage VREF.

For example, assuming that the driving voltage VDD is about or exactly 2.8V, the voltage change of the first node N1 by the photoelectric conversion element PD in the low gain mode, which is a high-light environment, is relatively larger compared to the low-light environment, so the voltage of the first node N1 may be assumed to be about or exactly 2.5V. And, assuming that the threshold voltage of the common source transistor CSX is, for example, about or exactly 0.2V, the voltage generator 190 in FIG. 1 may control the magnitude of the reference voltage VREF to have a value greater than about or exactly 2.3V (e/g/. about or exactly 2.0V to about or exactly 2.3V). Through the above-described operation, the common source transistor CSX may be turned off, and the potential of the first node N1 may be transferred to the source follower transistor SFX through the mode transistor MX and buffered.

That is, for example, if the reference voltage VREF is adjustable in a magnitude of ±0.1V with respect to about or exactly 2.4V, the voltage generator 190 in FIG. 1 may output a reference voltage VREF of about or exactly 2.3V to turn on the common source transistor CSX in high gain mode, and may output a reference voltage VREF of about or exactly 2.5V to turn off the common source transistor CSX in low gain mode. That is, the magnitude of the reference voltage VREF may be relatively lower in high gain mode than in low gain mode.

As described above, by turning on or off the mode transistor MX and adjusting the magnitude of the reference voltage VREF according to the high-light environment and the low-light environment, the pixel circuit 700 may obtain an improved conversion gain according to the light intensity in the current environment, thereby increasing the dynamic range and performance of the device.

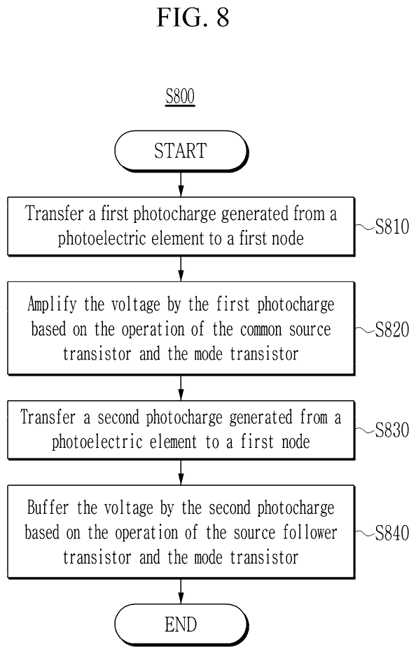

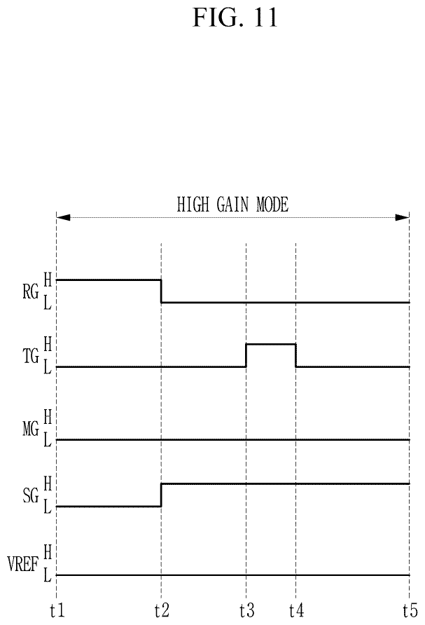

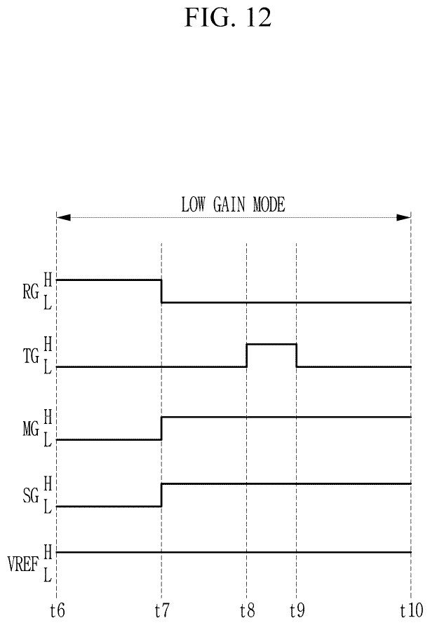

FIGS. 8 to 10 are flowcharts for explaining a method for driving an image sensor according to some example embodiments of the present disclosure. FIG. 11 and FIG. 12 are timing diagrams for explaining a method for driving an image sensor according to some example embodiments of the present disclosure.

Referring to FIG. 8, a method for driving an image sensor S800 may include a step of transferring a first photo charge generated from a photoelectric conversion element to a first node S810. For example, referring to FIG. 5, a photoelectric conversion element PD may generate a first photo charge, and when a transfer transistor TX is turned on by a high-level transfer control signal TG, the first photo charge generated by the photoelectric conversion element PD may be transferred to a first node N1. Here, the first photo charge may be generated in an environment where the amount of light reflected from the object is small, e.g., a low-light environment.

Specifically, referring to FIG. 6 and FIG. 11 together, the pixel circuit 600 may operate in high gain mode during the period between the first time point t1 and the fifth time point t5. In the interval between the first time point t1 and the second time point t2, the reset control signal RG may have a high level H. Accordingly, the reset transistor RX is turned on, so that the charge stored in the first node N1 may be reset to the driving voltage VDD.

At the second time point t2, the reset control signal RG may transition from a high level H to a low level L, thereby turning off the reset transistor RX. The selection control signal SG may transition from a low level L to a high level H, thereby turning on the selection transistor SX. Between the second time point t2 and the third time point t3, the photoelectric device PD may be exposed to light to generate a first charge. A photoelectric device PD may generate a first charge in a low-light environment.

In the interval between the third time point t3 and the fourth time point t4, the transfer control signal TG may have a high level H. Accordingly, the transfer transistor TX is turned on, so that the first charge generated by the photoelectric conversion element PD in a low-light environment may be transferred to the first node N1.

A method for driving an image sensor S800 may include a step of amplifying a voltage by a first photo charge based on the operation of a common source transistor and a mode transistor S820. For example, referring to FIG. 6, during the first period, the pixel circuit 600 may operate in a high gain mode. By adjusting the signal level of the mode control signal MG applied to the gate of the mode transistor MX and adjusting the magnitude of the reference voltage VREF applied to one end of the common source transistor CSX, the potential of the first node N1 may be amplified.

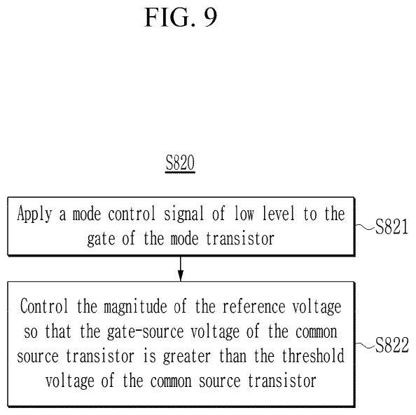

Specifically, referring to FIG. 9, the step of amplifying the voltage by the first photo charge based on the operation of the common source transistor and the mode transistor S820 may include the step of applying a low-level mode control signal to the gate of the mode transistor S821. For example, referring to FIG. 1, FIG. 6, and FIG. 11, the row driver 130 may apply a mode control signal MG of a low level L to the gate of the mode transistor MX between the second time point t2 and the fifth time point t5, and accordingly, the mode transistor MX may be turned off.

Also, referring to FIG. 9, the step of amplifying the voltage by the first photo charge based on the operation of the common source transistor and the mode transistor S820 may include a step of controlling the magnitude of the reference voltage so that the gate-source voltage of the common source transistor is greater than the threshold voltage of the common source transistor S822. For example, referring to FIG. 1, FIG. 6, and FIG. 11, the voltage generator 190 may apply a reference voltage VREF to one end of the common source transistor CSX such that the difference between the gate-source voltage of the common source transistor CSX, that is, the voltage of the first node N1, and the reference voltage VREF is greater than the magnitude of the threshold voltage of the common source transistor CSX during a period between a first time point t1 and a fifth time point t5, and thus the common source transistor CSX may be turned on. As the common source transistor CSX is turned on, the potential of the first node N1 may be amplified by the conversion gain of the common source transistor CSX.

The driving method of the image sensor S800 may include a step of transferring a second photo charge generated from a photoelectric conversion element to a first node S830. For example, referring to FIG. 5, the photoelectric conversion element PD may generate a second photo charge different from the first photo charge, and when the transfer transistor TX is turned on by a high-level transfer control signal TG, the second photo charge generated by the photoelectric conversion element PD may be transferred to the first node N1. Here, the second photo charge may be generated in an environment where a larger amount of light reflected from the object, e.g., a high-illuminance environment.

Specifically, referring to FIG. 7 and FIG. 12 together, the pixel circuit 700 may operate in low gain mode during the period between the sixth time point t6 and the tenth time point t10. In the interval between the sixth time point t6 and the seventh time point t7, the reset control signal RG may have a high level H. Accordingly, the reset transistor RX is turned on, so that the charge stored in the first node N1 may be reset to the driving voltage VDD.

At the seventh time point t7, the reset control signal RG may transition from a high level H to a low level L, thereby turning off the reset transistor RX. The selection control signal SG may transition from a low level L to a high level H, thereby turning on the selection transistor SX. Between the seventh time point t7 and the eighth time point t8, the photoelectric device PD may be exposed to light to generate second charge. Photoelectric devices PD may generate second charge in high-light environments.

In the interval between the eighth time point t8 and the ninth time point t9, the transfer control signal TG may have a high level H. Accordingly, the transfer transistor TX is turned on, so that the second charge generated by the photoelectric conversion element PD in a high-light environment may be transferred to the first node N1.

The driving method of the image sensor S800 may include a step of buffering a voltage by a second photo charge based on the operation of a source follower transistor and a mode transistor S840. For example, referring to FIG. 7, the pixel circuit 700 may operate in a low gain mode during a second period that is different from the first period. By adjusting the signal level of the mode control signal MG applied to the gate of the mode transistor MX and adjusting the magnitude of the reference voltage VREF applied to one end of the common source transistor CSX, the potential of the first node N1 may be buffered.

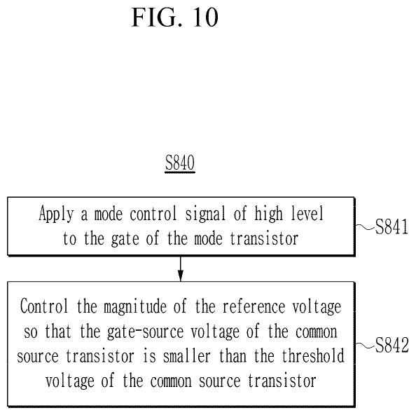

Specifically, referring to FIG. 10, the step of buffering a voltage by a second photo charge based on the operation of the source follower transistor and the mode transistor S840 may include a step of applying a high level mode control signal to the gate of the mode transistor S841. For example, referring to FIG. 1, FIG. 7, and FIG. 12, the row driver 130 may apply a mode control signal MG of a high level H to the gate of the mode transistor MX between the seventh time point t7 and the tenth time point t10, and accordingly, the mode transistor MX may be turned on.

Also, referring to FIG. 10, the step of buffering the voltage by the second photo charge based on the operation of the source follower transistor and the mode transistor S840 may include a step of controlling the magnitude of the reference voltage so that the gate-source voltage of the common source transistor is smaller than the threshold voltage of the common source transistor S842. For example, referring to FIG. 1, FIG. 7, and FIG. 12, the voltage generator 190 may apply a reference voltage VREF to one end of the common source transistor CSX such that the difference between the gate-source voltage of the common source transistor CSX, that is, the voltage of the first node N1, and the reference voltage VREF is smaller than the magnitude of the threshold voltage of the common source transistor CSX during a period between the sixth time point t6 and the tenth time point t10, and thus the common source transistor CSX may be turned off. As the common source transistor CSX is turned off, the potential of the first node N1 may be transferred to the source follower transistor SFX through the mode transistor MX and buffered.

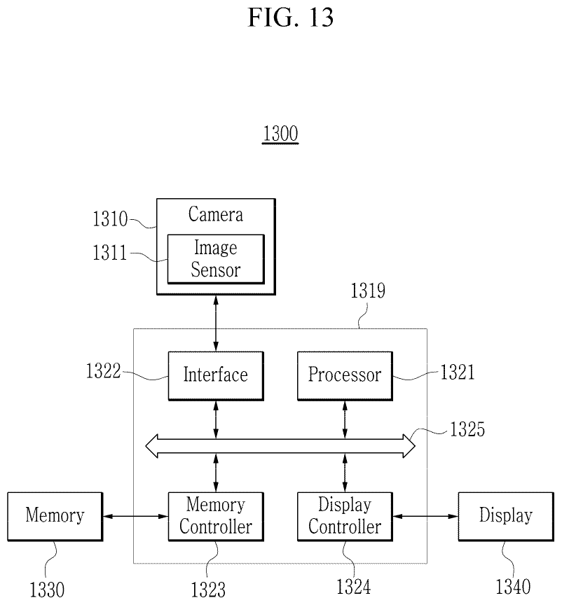

FIG. 13 is a block diagram for explaining a computing device according to some example embodiments of the present disclosure.

Referring to FIG. 13, a computing device 1300 may include a camera 1310, a controller 1319, a memory 1330, and a display 1340.

The camera 1310 may include an image sensor 1311. The image sensor 1311 may be implemented as an image sensor described with reference to FIGS. 1 to 12. The camera 1310 may generate an image signal using an image sensor 1311, perform image signal processing on the image signal, and output the processed image signal to the controller 1319.

In some example embodiments, the image sensor 1311 may include a mode transistor having a gate to which a mode control signal is applied, one end connected to a first node (e.g., a floating diffusion node) and the other end connected to a second node, a common source transistor having a gate connected to the first node, one end connected to the second node and the other end applied with a reference voltage, and a source follower transistor having a gate connected to the second node and one end connected to a driving voltage. When the illumination level is lower than a predetermined value, the mode transistor may be turned off based on a low-level mode control signal, and the common source transistor may be turned on based on a reference voltage that makes the gate-source voltage greater than the threshold voltage, so that the voltage of the first node may be amplified. When the illumination level is higher than a predetermined value, the mode transistor may be turned on based on a high-level mode control signal, and the common source transistor may be turned off based on a reference voltage that makes the gate-source voltage smaller than the threshold voltage, so that the voltage of the first node may be buffered. Accordingly, an improved conversion gain may be obtained according to high-light and low-light environments, thereby increasing the dynamic range.

The controller 1319 may include a processor 1321. The processor 1321 may control the overall operation of each component of the computing device 1300. The processor 1321 may be implemented as at least one of various processing units such as a central processing unit (CPU), an application processor (AP), and/or a graphic processing unit (GPU). In some example embodiments, the controller 1319 may be implemented as an integrated circuit or a system on chip (SoC).

In some example embodiments, as illustrated in FIG. 13, the controller 1319 may further include an interface 1322, a memory controller 1323, a display controller 1324, and a bus 1325. In some example embodiments, at least some of the interface 1322, memory controller 1323, display controller 1324, and/or bus 1325 may be provided external to the controller 1319. In some example embodiments, the controller 1319 may further include an image signal processor.

The interface 1322 may transmit an image signal received from the image sensor 1311 to the memory controller 1323 or the display controller 1324 through the bus 1325.

Memory 1330 may store various data and commands. The memory controller 1323 may control the transfer of data or commands to and from the memory 1330.

The display controller 1324 transmits data to be displayed on the display 1340 to the display 1340 under the control of the processor 1321, and the display 1340 may display a screen according to the received data. In some example embodiments, the display 1340 may further include a touch screen. The touch screen may transmit user input to the controller 1319 that may control the operation of the computing device 1300. User input may be generated when a user touches a touch screen.

The bus 1325 may provide communication capabilities between components of the controller 1319. The bus 1325 may include at least one type of bus depending on the communication protocol between the components.

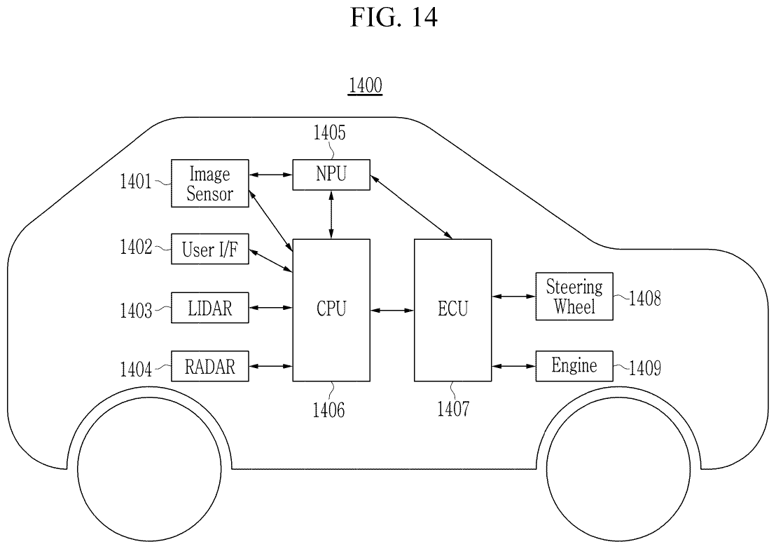

FIG. 14 is a block diagram for explaining a vehicle according to some example embodiments of the present disclosure.

Referring to FIG. 14, a vehicle 1400 may include an image sensor 1401, a user interface 1402, a LIDAR (Light Detection And Ranging) sensor 1403, a RADAR (Radio Detection And Ranging) sensor 1404, an NPU (Neural Processing Unit) 1405, a CPU 1406, and an ECU (Engine Control Unit)1407, and the ECU 1407 may receive a steering angle of the vehicle and a speed of the vehicle from a steering wheel 1408 and an engine 1409. In addition, although not shown, the vehicle 1400 may further include a communication module, an input/output module, a security module, a power control device, etc., and may further include various types of control devices.

Here, the image sensor 1401 may be the image sensor described with reference to FIGS. 1 to 12, respectively. In some example embodiments, the image sensor 1401 may include a mode transistor including a gate to which a mode control signal is applied, one end of which is connected to a first node (e.g., a floating diffusion node) and the other end of which is connected to a second node, a common source transistor including a gate connected to the first node, one end of which is connected to the second node and a reference voltage is applied to the other end, and a source follower transistor including a gate connected to the second node and one end of which is connected to a driving voltage. When the illumination level is lower than a predetermined value, the mode transistor may be turned off based on a low-level mode control signal, and the common source transistor may be turned on based on a reference voltage that makes the gate-source voltage greater than the threshold voltage, so that the voltage of the first node may be amplified. When the illumination level is higher than a predetermined value, the mode transistor may be turned on based on a high-level mode control signal, and the common source transistor may be turned off based on a reference voltage that makes the gate-source voltage smaller than the threshold voltage, so that the voltage of the first node may be buffered. Accordingly, an improved conversion gain may be obtained according to high-light and low-light environments, thereby increasing the dynamic range.

In some example embodiments, the vehicle 1400 may detect objects using information about the external environment acquired through sensors (e.g., an image sensor 1401, a LIDAR sensor 1403, and/or a RADAR sensor 1404). Sensors 1401, 1403, 1404 may capture images of objects, measure distances to objects, and transmit the images to processors (e.g., CPU 1406, NPU 1405, and ECU 1407). In addition to the sensors mentioned above, sensors 1401, 1403, 1404 may further include a Time of Flight (ToF) sensor, an ultrasonic sensor, an infrared sensor, a magnetic sensor, a position sensor (e.g., GPS) an acceleration sensor, a barometric pressure sensor, a temperature/humidity sensor, a proximity sensor, and a gyroscope sensor to detect objects.

The image sensor 1401 may provide image or light sensing and may be, for example, a complementary metal-oxide-semiconductor (CMOS) image sensor. An image sensor 1401 may obtain image or visual information about an object. For example, an image sensor 1401 may be attached to the front of a vehicle to capture driving images or measure the distance to an object located in front of the vehicle. The location where the image sensor 1401 is attached is not limited to this, and it may be attached to various locations to achieve the intended purpose of obtaining information about the object.

The image sensor 1401 may capture images of the environment surrounding the vehicle 1400. The vehicle 1400 may include at least two image sensors to capture 360-degree images around the vehicle, that is, images from all around the vehicle along one axis (e.g., substantially parallel to the ground), along two axis (e.g., substantially parallel to the ground and substantially perpendicular to the ground), and/or along further axis. In some example embodiments, the image sensor 1401 may be equipped with a wide-angle lens. In some example embodiments, four image sensors may be included in the vehicle 1400, for the front, rear, left side, and right side of the vehicle, but are not limited thereto, a single image sensor 1401 may be used to capture images of the vehicle's surroundings. The image sensor 1401 may continuously (for example, at all times or shorter intervals, e.g., every about or exactly 0.1 seconds) provide information about the surrounding environment of the vehicle to the vehicle 1400 by continuously capturing images of the surrounding environment of the vehicle.

An image sensed by the image sensor 1401 may be processed by the CPU 1406 and/or the NPU 1405. The CPU 1406 may detect an object by processing a sensed image in a motion-based manner, and the NPU 1405 may detect an object by processing a sensed image in a shape-based manner. The image sensor 1401 may be attached to the front of the vehicle to sense the external environment in front of the vehicle, but is not limited thereto and may be attached to various surfaces of the vehicle to sense the external environment.

Here, the image sensor 1401 may transfer photo charge generated from a plurality of photoelectric conversion elements and photo charge accumulated in a capacitor to a plurality of floating diffusion nodes in high-light and low-light environments.

The user interface 1402 may include various electronic devices and mechanical devices included in the driver's seat or passenger seat, such as the vehicle's instrument panel, a display showing driving information, a navigation system, and an air conditioning system.

The LIDAR sensor 1403 may measure the distance to an object by emitting a laser pulse and receiving the laser reflected from the object. A LIDAR sensor 1403 may typically include a laser, a scanner, a receiver, and a positioning system. Lasers generally use light with a wavelength of about or exactly 600 nm to about or exactly 1000 nm, but this may vary depending on the application. A scanner may quickly obtain information about the surrounding environment by scanning the surrounding environment being sensed, and there may be various types of scanners using a plurality of mirrors. The receiver may receive the laser pulse reflected from the target object, and detect and amplify the photons from the laser pulse. A positioning system may determine the position coordinates and direction of a device equipped with a receiver to implement a three-dimensional image. The LIDAR sensor 1403 and the RADAR sensor 1404 may be distinguished according to the effective measurement distance.

The RADAR sensor 1404 may measure the distance to an object by emitting electromagnetic waves and receiving the electromagnetic waves reflected from the target object, identify the object, and measure the position and moving speed of the object. The RADAR sensor 1404 may include a transmitter and a receiver. The transmitter may generate and output electromagnetic waves, and the receiver may receive echo waves reflected from a target object and process signals. The RADAR sensor 1404 may transmit and receive via a single antenna, but is not limited thereto. The frequency band of electromagnetic waves used in the RADAR sensor 1404 is a radio wave band or a microwave band, but may be changed depending on the purpose. In some example embodiments, a LIDAR sensor 1403 and a RADAR sensor 1404 may be attached to the vehicle to assist in determining the relative positional relationship between the vehicle and an object of interest. RADAR sensors 1404 may be divided into long radar sensors and short radar sensors.

NPU 1405 may receive input data, perform calculations using an artificial neural network, and provide output data based on the calculation results. The NPU 1405 may be a processor optimized (or improved) for simultaneous (e.g., at or about at the same time) matrix operations, capable of processing a plurality of operations in real time, and capable of learning on its own based on accumulated data to derive optimal values. NPU 1405 is optimized (or improved) for simultaneous matrix operations and may process a plurality of operations in real time. NPU 1405 may learn on its own based on accumulated data and derive local maxima in the current driving parameters.

In some example embodiments, the NPU 1405 may be a processor specialized for performing deep-learning type algorithms. For example, the NPU 1405 may be a processor specialized for performing deep-learning algorithms. For example, NPU 1405 is capable of processing operations based on various types of networks such as CNN (Convolution Neural Network), R-CNN (Region with Convolution Neural Network), RPN (Region Proposal Network), RNN (Recurrent Neural Network), Fully Convolutional Network, LSTM (Long Short-Term Memory) Network, and Classification Network. However, it is not limited to this, and various types of computational processing that simulate human neural networks are possible.

The NPU 1405 may receive a driving image from the image sensor 1401 and perform shape-based object detection based on the driving image. NPU 1405 may distinguish each of a plurality of objects in a driving video by extracting features of a plurality of objects and learning on its own based on accumulated data. For example, the NPU 1405 may extract objects that serve as criteria for driving judgment, such as vehicles, pedestrians, traffic lights, and lanes, from a single driving video based on features determined by using accumulated data as learning materials.

The CPU 1406 controls the overall operation of the vehicle 1400. The CPU 1406 may include one processor core (Single Core) or a plurality of processor cores (Multi-Core). The CPU 1406 may process or execute programs and/or data stored in memory. For example, the CPU 1406 may control the functions of the NPU 1405 and the ECU 1407 by executing programs stored in the memory.

The CPU 1406 may obtain the steering angle and vehicle speed from the ECU 1407. The steering angle is determined by the driver's operation of the steering wheel 1408, and may be processed by the ECU 1407 that controls the operation of the steering control device and provided to the CPU 1406. The vehicle speed may be measured based on at least one of the driver's use of the pedals (e.g., operation of the accelerator) the rotational speed of the engine 1409, and/or the wheel speed measured by the wheel sensor, and may be processed by the ECU 1407 that controls the speed of the vehicle and provided to the CPU 1406.

In addition, the CPU 1406 may determine the relative positional relationship between the vehicle and surrounding vehicles, and issue a command to maintain the rotation speed of the engine 1409 for constant speed driving to maintain a certain distance from surrounding vehicles according to a determined driving plan, and may issue a command to change the steering angle by adjusting the steering wheel 1408 left and right to perform an evasive maneuver when the vehicle and surrounding vehicles are less than a critical distance apart or when a surrounding vehicle cuts in. In FIG. 14, the steering wheel 1408 and the engine 1409 are disclosed as configurations related to the steering angle and vehicle speed, but are not limited thereto, and the steering angle and vehicle speed may be determined through various vehicle components.

The CPU 1406 may perform motion-based object detection in a driving video. Motion-based methods are methods that detect the degree of movement of an object over time and determine relative movement. Driving images may be acquired continuously for each frame through an image sensor 1401. For example, each frame may be captured at a rate of 60 frames per second (fps), so that the CPU 1406 may detect movement over time between image frames acquired every 1/60 of a second. Motion-based methods may include optical flow, which refers to the distribution of motion vectors of objects.

In addition to the image sensor 1401, the CPU 1406 may also auxiliary utilize the distance to an object obtained from the LIDAR sensor 1403 and the RADAR sensor 1404 to stably maintain the driving state of the vehicle. Additionally, the CPU 1406 may issue commands to control the state of the interior and exterior of the vehicle according to the driver's operation of the user interface 1402.

The ECU 1407 may be an electronic control device designed to control the overall operation or part of the operation of the vehicle. The ECU 1407 may control vehicle operation, such as operation of a combustion engine, operation of one or more electric motors, and/or vehicle parameters subject to driver control, such as a semi-automatic gearbox (SAGB) or an automatic gearbox (AGB), via a controller area network (CAN).

The ECU 1407 may electronically control the engine of the vehicle, the actuator of the steering control device, the transmission control system, the anti-lock brake system, the airbag control system, etc. by computer, and may provide the speed of the vehicle to the vehicle 1400 based on the rotation speed of the engine or the wheel speed measured by the wheel sensor, and may provide the steering angle of the vehicle to the vehicle 1400 from the steering control device.

In some example embodiments, the ECU 1407 may control the state of the steering wheel 1408 and the engine 1409 based on commands issued from the CPU 1406 and the NPU 1405. In some example embodiments, the ECU 1407 may accelerate or decelerate the vehicle in response to commands issued from the CPU 1406 and the NPU 1405, and may provide a signal to the engine 1409 to increase/decrease engine rotation speed for acceleration/deceleration. In addition, the ECU 1407 may change the steering wheel 1408 left and right for evasive maneuver when the distance from a surrounding vehicle is below a threshold distance or when a surrounding vehicle cuts in (cut-in object) according to a set driving plan.

In some example embodiments, the CPU 1406 or ECU 1407 may identify a fault in the ramp signal and cause the vehicle 1400 to exit autonomous driving mode. For example, the CPU 1406 or ECU 1407 may detect a defect in a ramp signal RAMP while driving in an autonomous driving mode based on an image sensor 1401, and immediately change the autonomous driving mode to a manual driving mode by the driver, thereby ensuring the safety of the user. For example, the vehicle 1400 may detect a defect in a ramp signal RAMP and stop a driving assistance function based on the ramp signal RAMP, thereby ensuring the safety of the driver or user.

Although the ECU 1407 is depicted in the drawing as being installed in the vehicle separately from the CPU 1406, it is not limited thereto and the vehicle control function of the ECU 1407 may be performed together while being included within the CPU 1406. In this case, the CPU 1406 may be understood to have at least two processor cores (multi-core). In FIG. 14, the ECU 1407 is depicted as a separate component from the CPU 1406, but is not limited thereto and may exist within the CPU 1406.

Although not shown in FIG. 14, the vehicle 1400 may further include a communications module. The communication module may transmit data to the outside of the vehicle 1400 or receive data from the outside. For example, the communication module may communicate with an external object of the vehicle 1400. In this case, the communication module may perform communication in V2X (Vehicle to Everything) mode. For example, the communication module may perform communication in the V2V (Vehicle to Vehicle), V2I (Vehicle to Infra), V2P (Vehicle to Pedestrian), and V2N (Vehicle to Nomadic Devices) modes. However, the present inventions are not limited thereto, and the communication module may transmit and receive data by various known communication methods. For example, the communication module may perform communication by, for example, 3G, 4G (LTE), 5G, Wi-Fi, Bluetooth, BLE (Bluetooth Low Energy), Zigbee, NFC (Near Field Communication), ultrasonic communication, etc., and may include both short-range communication and long-range communication.

According to some example embodiments of the present inventions for solving these technical problems, a vehicle may include a user interface, a Light Detection And Ranging (LIDAR) sensor, a Radio Detection And Ranging (RADAR) sensor, a Neural Processing Unit (NPU), processing circuitry, an engine control unit, and an image sensor. The image sensor may include a photoelectric conversion element configured to generate photo charge, a first node configured to accumulate the photo charge generated from the photoelectric conversion element, a transfer transistor connected between the first node and the photoelectric conversion element, a reset transistor connected between the first node and a driving voltage, a common source transistor including a gate connected to the first node and connected between a second node and a reference voltage, the common source transistor configured to amplify a voltage caused by the photo charge, and a source follower transistor including a gate connected to the second node and having an end connected to the driving voltage, the source follower transistor configured to buffer the voltage caused by the photo charge. In some example embodiments of the vehicle, the image sensor may be configured to capture images of an environment surrounding the vehicle

When the terms “about” or “substantially” are used in this specification in connection with a numerical value, it is intended that the associated numerical value includes a manufacturing or operational tolerance (e.g., ±10 %) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10 %) around the stated numerical values or shapes.

As used herein, expressions such as “one of,” “one or more of,” “any one of,” “at least one of,” and “at least one selected from” when preceding a list of elements, modify the entire list of elements and do not modify the individual elements of the list. Thus, for example, both “at least one of A, B, or C” and “at least one of A, B, and C” mean either A, B, C, or any combination thereof. Likewise, A and/or B means A, B, or A and B. While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

Although some example embodiments of the present inventions have been described in detail above, the scope of the present inventions are not limited thereto, and various modifications and improvements made by those skilled in the art using the basic concept of the present inventions defined in the following claims also fall within the scope of the present inventions.

What is claimed is:

1. An image sensor, comprising:
a photoelectric conversion element configured to generate photo charge;
a first node configured to accumulate the photo charge generated from the photoelectric conversion element;
a transfer transistor connected between the first node and the photoelectric conversion element;
a reset transistor connected between the first node and a driving voltage;
a common source transistor including a gate connected to the first node and connected between a second node and a reference voltage, the common source transistor configured to amplify a voltage caused by the photo charge; and
a source follower transistor including a gate connected to the second node and having an end connected to the driving voltage, the source follower transistor configured to buffer the voltage caused by the photo charge.

2. The image sensor of claim 1, further comprising:
a mode transistor including a gate configured to receive a mode control signal and connected between the first node and the second node.

3. The image sensor of claim 2, wherein:
the common source transistor is configured to output a gate-source voltage smaller than a threshold voltage of the common source transistor based on a magnitude of the reference voltage and the mode control signal received by the gate of the mode transistor being at a high level during a first period.

4. The image sensor of claim 3, wherein:
the common source transistor is configured to output the gate-source voltage greater than the threshold voltage of the common source transistor based on the magnitude of the reference voltage and the mode control signal received by the gate of the mode transistor being at a low level during a second period different from the first period.

5. The image sensor of claim 4, wherein:
the first period corresponds to a section where an illumination level is higher than an illumination threshold value, and the second period corresponds to a section where the illumination level is lower than the illumination threshold value.

6. The image sensor of claim 2, further comprising:
a row driver configured to output the mode control signal at a high level based on an illumination level being higher than an illumination threshold value, and to output the mode control signal at a low level based on the illumination level being lower than the illumination threshold value.

7. The image sensor of claim 2, further comprising:
a voltage generator configured to output the reference voltage having a magnitude such that a gate-source voltage of the common source transistor is smaller than a threshold voltage of the common source transistor based on an illumination level being higher than a illumination threshold value, and to output the reference voltage having a magnitude such that the gate-source voltage of the common source transistor is greater than the threshold voltage of the common source transistor based on the illumination level being lower than the illumination threshold value.

8. The image sensor of claim 2, further comprising:
a selection transistor including a gate configured to receive a selection control signal and having an end connected to the source follower transistor, and configured to output an output voltage as a pixel signal.

9. A method for driving an image sensor, comprising:
transferring a first photo charge generated from a photoelectric conversion element to a first node;
amplifying a voltage caused by the first photo charge based on an operation of a common source transistor including a gate connected to the first node and connected between a second node and a reference voltage, and an operation of a mode transistor connected between the first node and the second node;
transferring a second photo charge generated from the photoelectric conversion element to the first node; and
buffering a voltage caused by the second photo charge based on an operation of a source follower transistor including a gate connected to the second node and having an end connected to a driving voltage, and an operation of the mode transistor.

10. The method for driving the image sensor of claim 9, wherein amplifying the voltage by the first photo charge based on the operation of the common source transistor and the mode transistor comprises:
applying a mode control signal at a low level to a gate of the mode transistor.

11. The method for driving the image sensor of claim 10, wherein amplifying the voltage by the first photo charge based on the operation of the common source transistor and the mode transistor further comprises:
controlling a magnitude of the reference voltage such that a gate-source voltage of the common source transistor is greater than a threshold voltage of the common source transistor.

12. The method for driving the image sensor of claim 9, wherein buffering the voltage caused by the second photo charge based on the operation of the source follower transistor and the mode transistor comprises:
applying a mode control signal at a high level to a gate of the mode transistor.

13. The method for driving the image sensor of claim 12, wherein buffering the voltage caused by the second photo charge based on the operation of the source follower transistor and the mode transistor further comprises:
controlling a magnitude of the reference voltage such that a gate-source voltage of the common source transistor is smaller than a threshold voltage of the common source transistor.

14. The method for driving the image sensor of claim 9, wherein:
amplifying the voltage by the first photo charge is performed in a first period, and
buffering the voltage by the second photo charge is performed in a second period different from the first period.

15. The method for driving the image sensor of claim 14, wherein:
the first period corresponds to a section where an illumination level is lower than an illumination threshold value, and the second period corresponds to a section where the illumination level is higher than the illumination threshold value.

16. An image sensor, comprising:
a pixel circuit comprising
a photoelectric conversion element configured to generate photo charge,
a first node configured to accumulate the photo charge generated from the photoelectric conversion element,
a mode transistor including a gate configured to receive a mode control signal and connected between the first node and a second node,
a common source transistor including a gate connected to the first node and connected between the second node and a reference voltage, the common source transistor configured to amplify a voltage caused by the photo charge, and
a source follower transistor including a gate connected to the second node and having an end connected to a driving voltage, the source follower transistor configured to buffer the voltage caused by the photo charge;
a row driver configured to control a signal level of the mode control signal based on an illumination level; and
a voltage generator configured to control a magnitude of the reference voltage based on the illumination level.

17. The image sensor of claim 16, wherein:
the row driver is configured to output the mode control signal at a high level based on the illumination level being higher than an illumination threshold value.

18. The image sensor of claim 17, wherein:
the voltage generator is configured to output the reference voltage having a magnitude such that a gate-source voltage of the common source transistor is smaller than a threshold voltage of the common source transistor based on the illumination level being higher than the illumination threshold value.

19. The image sensor of claim 16, wherein:
the row driver is configured to output the mode control signal at a low level based on the illumination level being lower than a illumination threshold value.

20. The image sensor of claim 19, wherein:
the voltage generator is configured to output the reference voltage having a magnitude such that a gate-source voltage of the common source transistor is greater than a threshold voltage of the common source transistor based on the illumination level being lower than the illumination threshold value.
